(19) United States
(12) Patent Application Publication
(10) Pub. No.: US 2017/0339141 A1
(43) Pub. Date: Nov. 23, 2017

(54) System and Method of Identity Verification

(71) Applicant: Azurecoast, LLC, Las Vegas, NV (US)

(72) Inventor: Jon Richard Doyle, Emeryville, CA (US)

(21) Appl. No.: 15/600,424

(22) Filed: May 19, 2017

Related U.S. Application Data
(60) Provisional application No. 62/339,440, filed on May 20, 2016.

(51) Int. Cl. H04L 29/06; H04M 1/67; G06F 17/30; H04W 12/06

(52) U.S. Cl. CPC H04L 63/0861; H04W 12/06; H04M 1/67; G06F 17/30; H04L 29/06; H04L 63/0853

(57) ABSTRACT

A system and method of identity verification is disclosed. The system has a processor and an identity confirmation function. The identity confirmation function executable by the processor to provide a caller identity confirmation if a result indicates an obtained fingerprint data, from a fingerprint scan on the caller electronic device occurring during the audio call resulting from the fingerprint scan request, matches a stored fingerprint data associated with the caller.

This application claims the benefit of U.S. Provisional Patent Application No. 62/339,440, filed on May 20, 2016, which is hereby incorporated by reference.

### FIELD OF THE INVENTION

This invention relates in general to systems and methods of identity verification.

### BACKGROUND OF THE INVENTION

The need or desire to verify the identity of a person arises in many contexts. One environment where identity verification can be used is a call center or a place where calls are received into an organization. Another environment where identity verification can be used is an environment where information is sensitive and it is important to prevent confidential information or other information from being conveyed to or accessed by unauthorized persons.

The present inventor recognized that many of the pieces of information that are used to verify the identity of a person are limited to what a human can speak into a phone or enter into a keypad or keyboard. The present inventor has recognized that identity confirmation information that can be provided verbally or into a keypad or keyboard are susceptible to theft or otherwise fraudulent impersonation.

Some systems of identity confirmation require multiple different pieces of information to be conveyed to the person or entity seeking to verify identity to increase security and decrease the chances of fraud or unauthorized access. The present inventor recognized that as more and more pieces of information are required, it can become frustrating to the caller or user who must convey such information. Further, the more information required the more likely it might be that a person could forget the answers to the questions that are being asked of them. If certain security information is not remembered by the user, additional procedures and inquiries may be required to reset or access such information, which further prolong the identity verification process.

Further, the present inventor recognized that some organizations do not have efficient workflows, so that when a caller or user is transferred from one person to another person, such as a supervisor, the caller or user may have to repeat the identity confirmation information multiple times during the process.

The present inventor recognized the need for a more efficient and easier system and method of confirming the identity of the user or caller. The present inventor is recognized the need for a system and method of confirming the identity of a user or caller that does not require the user or caller to remember as much security information. The present inventor recognized the need for a system and method that would reduce fraud and increase customer satisfaction and security.

### SUMMARY OF THE INVENTION

A system and method of identity verification is disclosed. In some embodiments, the system comprises a computer. The computer comprises a processor, a caller device identifying function, a fingerprint scan request function, a fingerprint scan result receiving function, and an identity confirmation function.

The caller device identifying function is executable by the processor to identify a caller electronic device corresponding to caller identification information received from a caller during an identity audio call. The fingerprint scan request function is executable by the processor to send a fingerprint scan request via a computer network to the caller electronic device during the audio call. The fingerprint scan result receiving function is executable by the processor to receive a result the following fingerprint scan request from the caller electronic device during the audio call. The identity confirmation function is executable by the processor to provide a caller identity confirmation if the result indicates an obtained fingerprint data, from a fingerprint scan on the caller electronic device occurring during the audio call resulting from the fingerprint scan request, matches a stored fingerprint data associated with the caller.

A method of biometrically confirming the identity of a caller is disclosed. In some embodiments, a caller electronic device is identified corresponding to caller identification information received from a caller during an audio call. A fingerprint scan request is sent via a computer network to the caller electronic device during the audio call. A result is received following the fingerprint scan request from the caller electronic device during the audio call. A caller identity confirmation is provided if the result indicates an obtained fingerprint data from a fingerprint scan on the caller electronic device, occurring during the audio call resulting from the fingerprint scan request, matches a stored fingerprint data associated with the caller.

A method of biometrically confirming the identity of an intended message recipient is disclosed. In some embodiments, a recipient electronic device is identified corresponding to an intended message recipient. A fingerprint scan request is sent via a computer network to the recipient electronic device. A result is received following the fingerprint scan request from the recipient electronic device. A message for access by the intended message recipient is transmitted to the recipient electronic device if an obtained fingerprint data, from a fingerprint scan on the recipient electronic device resulting from the fingerprint scan request, matches a stored fingerprint data associated with the intended message recipient.

A method of biometrically confirming whether a transaction is authorized is disclosed. In some embodiments, an authorized electronic device is identified corresponding to a transaction and an authorized user. A fingerprint scan request is sent via a computer network to the authorized electronic device. A result is received following the fingerprint scan request from the authorized electronic device. The transaction indicated as authorized if an obtained fingerprint data from a fingerprint scan on the caller electronic device resulting from the fingerprint scan request matches a stored fingerprint data associated with the intended message recipient.

Numerous other advantages and features of the present invention will become readily apparent from the following detailed description of the invention and the embodiments thereof, from the claims, and from the accompanying drawings.

### BRIEF DESCRIPTION OF THE DRAWINGS

FIG. 1 is a block diagram of an exemplary environment where an identity verification system of the invention can be used.

FIG. 2 is a block diagram of one embodiment of the identity verification system.

FIG. 3 is a block diagram of a second embodiment of the identity verification system.

FIG. 4 is a front view of an exemplary client device usable with the identity verification system.

FIG. 5 is a top diagram view of a fingerprint sensor of the client device of FIG. 4.

FIG. 6 is a side diagram view of the fingerprint sensor of the device of FIG. 4.

FIG. 7 is a block diagram of a first embodiment architecture of the client device of FIG. 4.

FIG. 8 is a block diagram of a second embodiment architecture of a client device usable with the identity verification system.

FIG. 9 is a block diagram of one embodiment of a processor and data storage architecture of a client device usable with the identity verification system.

FIG. 10 is a flow diagram of a first embodiment user account registration function of the identity verification system.

FIG. 11 is a block diagram of a first embodiment user record of the identity verification system.

FIG. 12 is a flow diagram of a second embodiment user account registration function of the identity verification system.

FIG. 13 is a block diagram of a second embodiment user record of the identity verification system.

FIG. 14 is a flow diagram of audio communication session authorization function of the identity verification system.

FIG. 15 is a flow diagram of a biometric authentication function of the identity verification system.

FIG. 16 is a flow diagram of an event triggered verification function(s) of the identity verification system.

FIG. 17 is a block diagram of an exemplary server computer architecture usable with the identity verification system.

### DETAILED DESCRIPTION

The following description is presented to enable any person skilled in the art to make and use the invention. For the purposes of explanation, specific nomenclature is set forth to provide a plural understanding of the present invention. While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

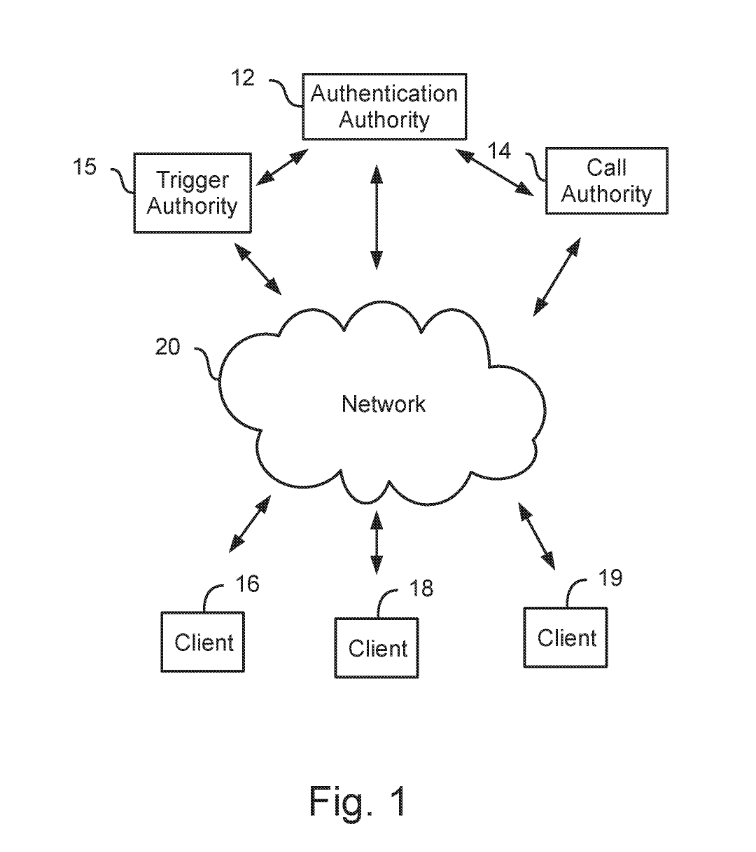

FIG. 1 shows an example operating environment for an identity verification system 10. In one embodiment, the system 10 comprises an authentication authority 12 and a user client device 16. The system may optionally comprise or interact with a call authority 14, a trigger authority 15, or other system or server. The client device 16 may comprise a biometric sensor, such as a fingerprint sensor.

FIG. 1 shows that multiple user client devices 16, 18, 19 can connect to the authentication authority 12 across the network 20. FIG. 2 shows communications and instruction routes between the various components of a first embodiment of the system 10 across the network 20. Such communications and/or instructions routes may be wired and/or wireless communications and/or instructions routes. The authentication authority 12 is in electronic or signal communication to the user client device 16 and the call authority 14. The end user 22 uses the user client device 16. In one embodiment, a human call agent 24 interfaces with the call authority 14 directly or through a call agent client device (not shown).

The end user 22 may initiate an audio communication session, such as call, with the call agent 24 or directly with the call authority 14, such as in the case of an interactive voice response (IVR) system, via a public switched telephone network (PSTN), or another network using a voice over IP (VoIP) protocol or other protocol.

In some embodiments, the connection between the authentication authority and the call authority may be an encrypted or secured communication channel or the communications between the authentication authority and the call authority maybe encrypted before they are sent across a public network. In some embodiments, communications between the authentication authority and the client devices 16, 18, 19 are encrypted. The encryption may comprise public key cryptography. In public key cryptography, such as asymmetric key encryption, encryption performed with one key can be decrypted only by the other member of the key pair. Possession of one key does not enable the practical derivation of the other key. Therefore, the public key can be used to decrypt a message that was encrypted with the corresponding private key to result in the original message. The private key can be used to decrypt a message that was encrypted with the corresponding public key to result in the original message.

Asymmetric key encryption relies on cryptographic algorithms, which are based on mathematical problems that have no efficient solution, including but not limited to those in integer factorization, discrete logarithm, and elliptic curve relationships. A strength of asymmetric key encryption is in the impossibility or computational impracticality for a private key to be derived or determined from its corresponding public key. Therefore, a public key can be disseminated publicly without compromising security. But the private key needs to be kept secret, such as remaining known only to the private key owner.

One exemplary algorithm for asymmetric key encryption is that generally known as RSA. One implementation of RSA is described in U.S. Pat. No. 4,405,829, which is herein incorporated by reference. Certain elliptic curve cryptography systems and other exemplary cryptography systems are described in U.S. Pat. No. 5,159,632, which is herein incorporated by reference. Other asymmetric key encryption algorithms can be used. A cryptographic hash function may be used together with the public key encryption algorithm.

U.S. Pat. No. 8,954,754 discloses a SHA-1 cryptographic hash algorithm in the background section of the patent, which is herein incorporated by reference. Other cryptographic hash algorithms can be used.

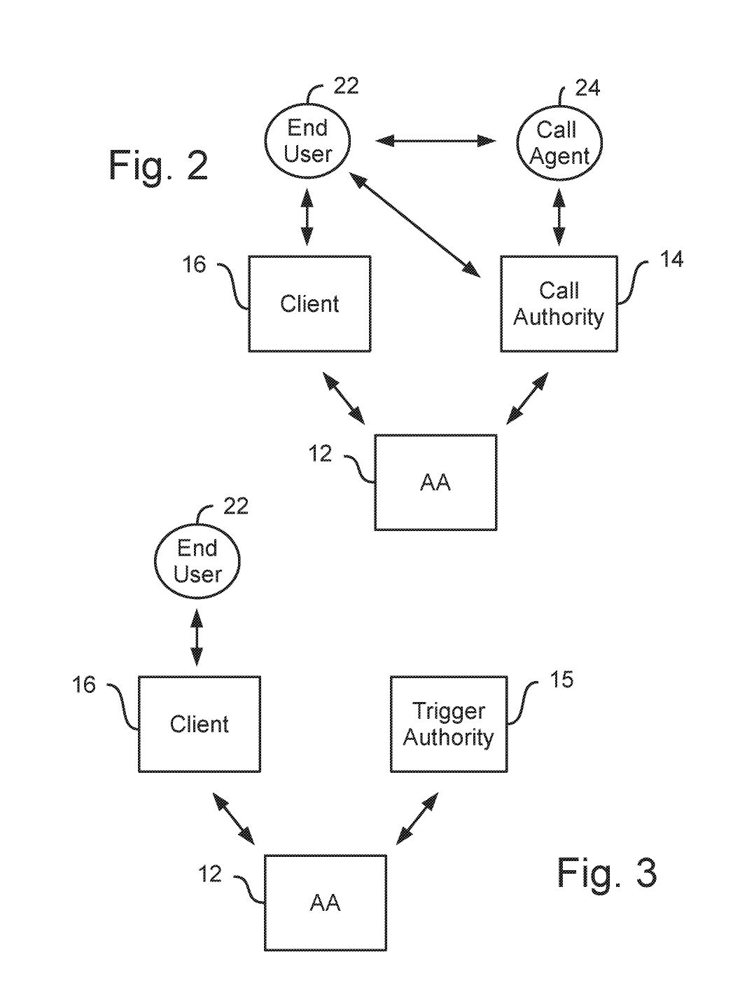

FIG. 3 shows communications and instruction routes between the various components of a second embodiment of the system 10 across the network 20. Such communications and/or instruction routes may be wired and/or wireless communications and/or instructions routes. The authentication authority 12 is in electronic or signal communication with the user client device 16 and the trigger authority 15. The authentication authority may be in communication with other servers, systems, or components.

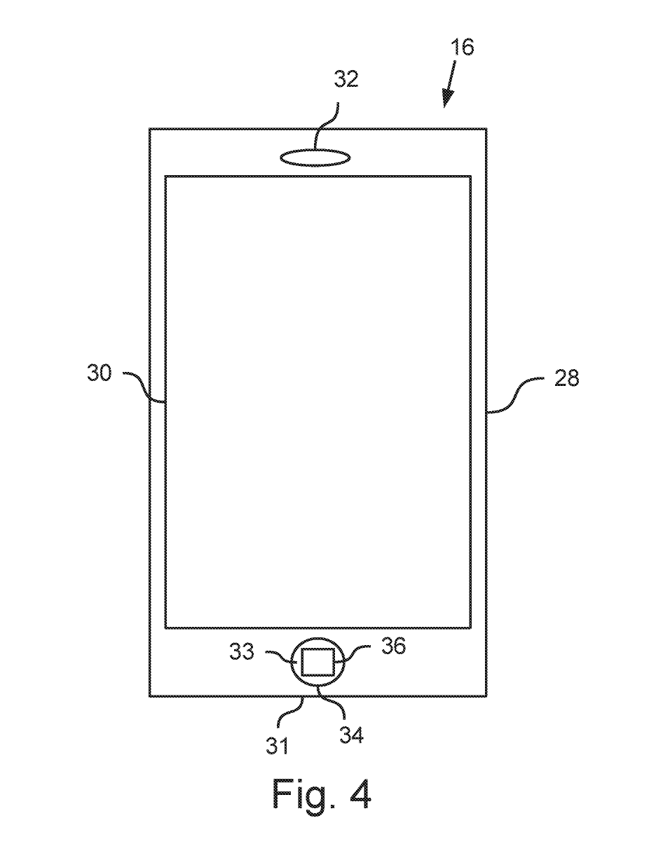

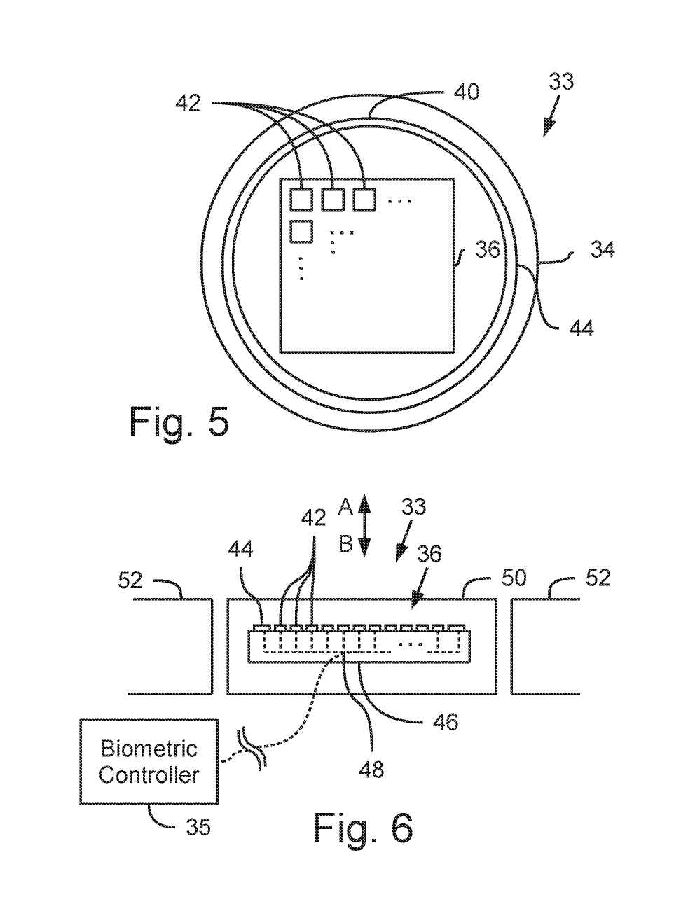

The client devices 16, 18, 19 comprise a fingerprint sensor 33. In some embodiments, the fingerprint sensor is a capacitance, optical, ultrasonic, or other fingerprint sensor. In some embodiment, the capacitance fingerprint sensor is passive or active. One embodiment of the client device 16 is shown in more detail in FIG. 4. In some embodiments, the device 16 comprises a body 28, a display 30, a speaker 32, and a fingerprint sensor 33. The display may comprise a touch surface 80. The sensor 33 is shown in more detail in FIGS. 5 and 6.

In some embodiments, the fingerprint sensor 33 comprises an array of biometric sensing pixels or electrodes carried on a semiconductor substrate. One exemplary array 36 of biometric sensing pixels or electrodes 42 on a semiconductor substrate 46 is shown as a two dimensional array in FIGS. 5 and 6. In some embodiments, the array 36 comprises 90 to 100 rows and 90 to 100 columns of electrodes 42. Other numbers of electrodes and other array shapes may be used. For example, the array 36 may include more than 100 electrodes 42, 500 or more electrodes 42, 1000 or more electrodes 42, 5000 or more electrodes, or another suitable number of electrodes. An outer electrode 44 surrounds the array 36. The outer electrode 44 may have a circular shape as shown in FIG. 4. The outer electrode 44 may have other shapes such as an oval shape, a rectangular ring shape, a square ring shape, or other suitable shaped ring or otherwise.

The sensor 33 is connected to a biometric controller 35. The controller may contain a signal source. In operation, a user may swipe a finger across the electrode 44 and array 36 or may place a finger on or over the electrode 44 and array 36. The signal source of the biometric controller 35 drives an alternating current signal (e.g. a signal from 1 to 5 MHz or other suitable frequency) into electrode 44. The drive may be coupled to the user's finger from the electrode 44 when the user's finger is placed on or over the electrode 44, for example due to contact of the user's finger with at least some of the electrode 44 or due to a close proximity of the finger to the electrode 44 in cases where electrode 44 and the users finger are separated by an air gap or a layer of plastic, glass, or other dialectic. Individual signal lines or routes may be connected from each of the electrodes 42, 44 to the biometric controller. Therefore the biometric controller 35 can read signals from each individual electrode 42, 44.

The magnitude of the drive signal imparted through the user's finger from the electrode 44, and therefore coupled to each of the electrodes 42 by the user's finger, can be measured by monitoring the signals from each electrode 42 on the individual signal lines or routes. As a fingerprint ridge is located over or passes over electrodes 42, different amounts of the signal are coupled or transferred into electrodes 42 from the finger. The higher the capacitance, the nearer the surface of an adjacent or overlying finger to the electrode 42. Fingerprint ridges provide a higher capacitance in an underlying electrode than do fingerprint valleys because the ridges are closer to the electrodes than the valleys. By providing a sufficiently dense array 36 of electrodes 42 in sensor 33, such as one or more per mm, 10 or more per mm, or 100 or more per mm, the biometric controller 35 may be used to capture a digital representation of the user's fingerprint.

In some embodiments, the fingerprint sensor 33 is mounted to a push button 34 of the device 16. The push button is depressible in the direction B, returnable in the direction A, relative to the surrounding housing 52 of the device 16. In some embodiments, the fingerprint sensor 33 is mounted to, on, or, about other areas of the client device 16. In some embodiments, the fingerprint sensor, the fingerprint sensing device, and method of fingerprint sensing is that disclosed in U.S. Pat. Nos. 6,259,804 and/or 8,736,001, each of such patents are incorporated by reference. In some embodiments, the fingerprint sensor, the fingerprint sensing device, and method of fingerprint sensing is that disclosed in U.S. Patent Application Publication No. 2013/0315451. U.S. Patent Application Publication No. 2013/0315451 is herein incorporated by reference.

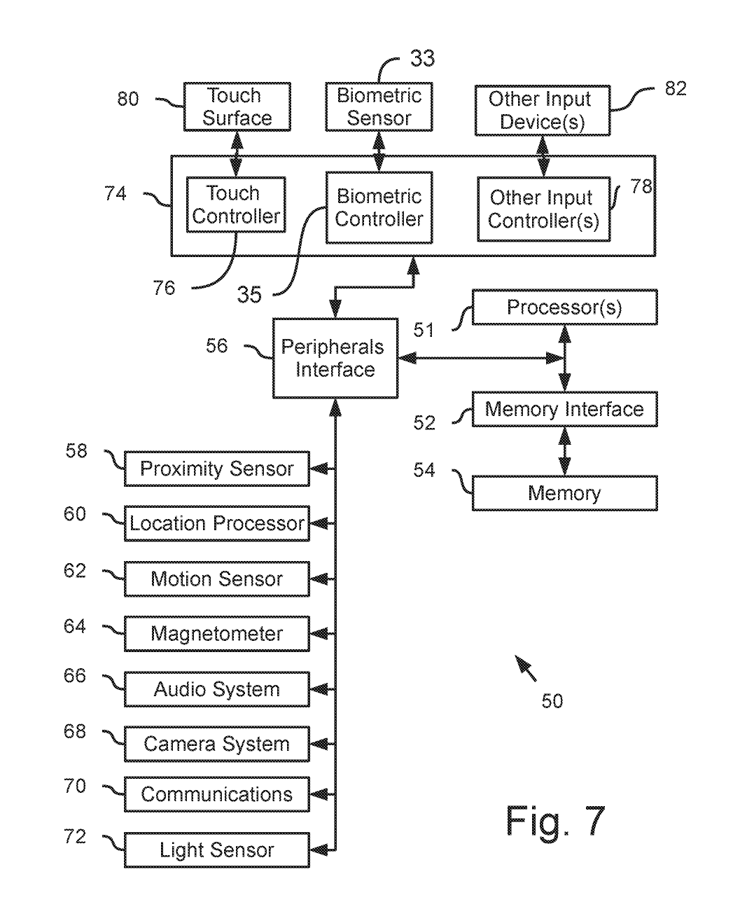

FIG. 7 provides a block diagram of a first embodiment client device architecture 50 of client device 16 for implementing the features and processes described herein. Other client architectures are possible, including architectures with more or fewer components. The architectures may be implemented in any mobile or stationary electronic device for implementing the features described herein, including but not limited to, desktop computers, portable computers, smart phones, tablet computers, wearable computers, portable electronics, and the like.

The architecture 50 provides a processor 51 connected to a memory interface 52 and a peripheral interface 56 across one or more internal communication channels, such as a bus(es). The memory interface 52 is coupled or otherwise signal connected to the memory 54. A proximity sensor 58, a location sensor 60, a motion sensor 62, and a magnetometer 64, an audio system 66, a camera system 68, a communication system 70, and a light sensor 72 may each be connected to the peripheral interface. An input output system 74 may also be connected to the peripheral interface.

Communications capabilities and functions may be facilitated through one or more communications systems 70, such as a wireless communication system and/or a wired communications system. The wireless communications systems may include radio frequency receivers and transmitters and/or optical receivers and transmitters. The wired communications system may include a port, such as a universal serial bus port, or other wired port connection that may be used to establish a wired connection to other computing devices.

The design of the communications system may correspond to the communication network(s) or medium(s) on or over which the device is intended to operate. For example, the wireless communication system may be designed to operate using standard or otherwise known protocols, such as, GPRS, enhanced data GSM environment (EDGE), IEEE 802.x (e.g., WiFi, WiMax), global system for mobile communications (GSM), code division multiple access (CDMA), Near Field Communications (NFC), Bluetooth® (including Bluetooth® low energy (BLE) and classic Bluetooth®). The wireless communication system may be configured to synchronize with a host device using one or more protocols, such as, for example, the TCP/IP protocol, HTTP protocol, UDP protocol, and any other known or standardized protocol.

The input/output system or I/O system 75 may comprise a touch controller 76, the biometric controller 35, and one or more other input controllers 78. The touch controller 76 is connected to a touch surface 80. Touch surface 80 and touch controller 76 may be configured to detect contact and movement or a break of contact or a break of movement using one or more touch sensitivity technologies, such as capacitive, infrared, resistive, and surface acoustic wave technologies, as well as other proximity sensor arrays or other elements for determining one or more points of contact with touch surface 80. In one embodiment, the touch surface is configured to display a virtual keyboard and/or other virtual buttons for use as an input/output device by the user.

The other input/output controllers 78 are connectable with other input/output devices 82, such as an infrared port, a USB port, a pointer device, a rocker switch, and/or one or more other buttons. In some applications, the one or more buttons may comprise an up and down button for volume control of a speaker and/or a microphone connected to the audio system 66.

The audio system 66 may be connected to one or more speakers, such as speaker 32, and one or more microphones, such as microphone 31, for facilitating audio playback and for facilitating voice enabled functions, such as voice recognition, digital recording, and telephony functions. The camera system 68 may be connected to one or more cameras or optical sensors capable of capturing still image(s) and video. The optical sensor may be a complementary metal-oxide semiconductor optical sensor or a charged coupled device. The motion sensor may comprise an accelerometer and a gyroscope.

The location processor 60 may comprise a GPS chip. The location processor may be used to provide georeferencing. The magnetometer can provide data to determine magnetic North.

The devices, systems, and sensors can facilitate multiple functionalities of the device. For example, light sensor 72, the proximity sensor 58, and the motion sensor 62 can facilitate orientation, lighting, and proximity functions of the device. In some embodiments, the motion sensor 62 may be utilized to detect movement and orientation of the device. Other sensors, such as a temperature sensor, another biometric sensor, or other sensing devices may be connected to the peripherals interface 56 to facilitate related functions.

The memory 54 may comprise random access memory, non-volatile memory, such as one or more magnetic disk storage devices, one or more optical storage devices, and/or flash memory. The memory 54 may store an operating system and operating system instructions, such as OS X, ANDROID, Darwin, RTXC, LINUX, UNIX, WINDOWS, or VxWorks. The operating system instructions may provide for handling basic system services and for performing task involving hardware components.

The memory 54 may comprise communication instructions to facilitate communicating with one or more additional devices, one or more computers or servers, such as described herein. The memory may comprise graphical user interface (GUI) instructions to facilitate graphic user interface processing, including a touch model for interpreting touch inputs and gestures. The memory may comprise sensor processing instructions to facilitate sensor-related functions. The memory may comprise phone instructions to facilitate phone-related functions. The memory may comprise electronic messaging instructions to facilitate electronic-messaging related functions. The memory may comprise web browsing instructions to facilitate web browsing-related functions. The memory may comprise media processing instructions to facilitate media processing-related functions. The memory may comprise GPS/Navigation instructions to facilitate GPS and navigation-related functions. The memory may comprise camera instructions to facilitate camera-related functions. The memory may comprise fingerprint sensor instructions for facilitating fingerprint recognition functions. The memory may comprise other instructions, such as for performing some or all of the processes and functions described herein, such as regarding client device 16.

Each of the above identified instructions and applications may correspond to a set of instructions for performing one or more functions described. These instructions do not need to be implemented as separate software programs, procedures, or modules. Memory 54 may include additional instructions or fewer instructions. Further, various functions of the device may be implemented in hardware and/or in software, including in one or more signal processing and/or application specific integrated circuits.

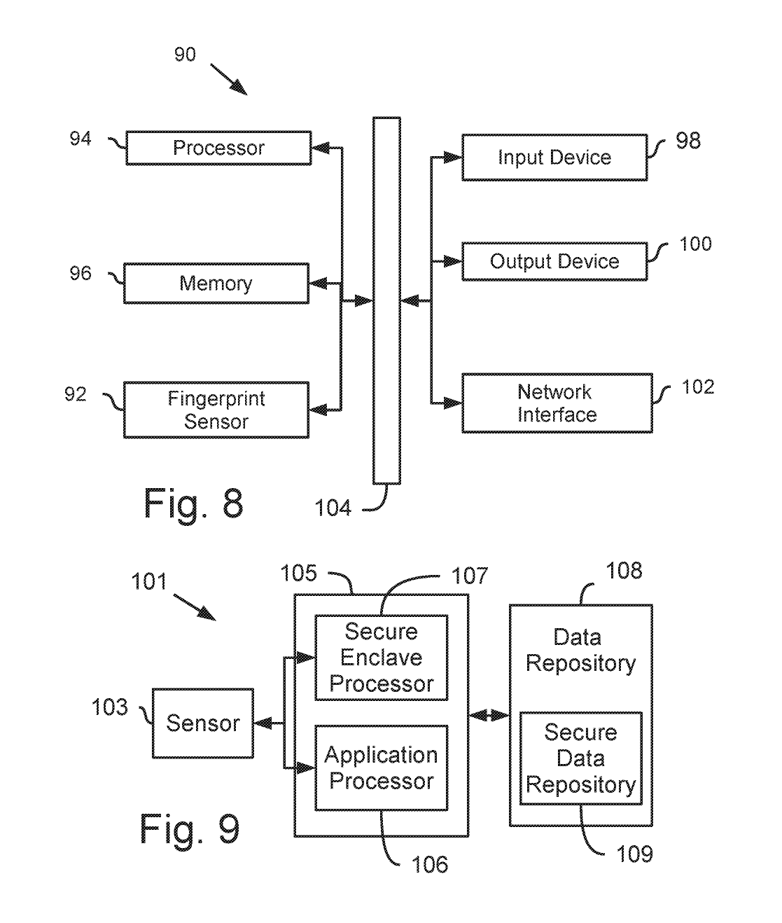

FIG. 8 shows the second embodiment client device architecture 90 of client device 16 for implementing the features and processes described herein. The architecture 90 comprises a processor 92, a memory 94, a fingerprint sensor 96, which may be sensor 33, an input device 98, an output device 100, a wired and/or wireless receiver or transceiver 102, and one or more internal communication channels 104 connecting the forgoing components. The architecture 90 may have an input/output device in place of a separate input device 98 and output device 100. The memory 94 may comprise random access memory, non-volatile memory, such as one or more magnetic disk storage devices, one or more optical storage devices, and/or flash memory.

In some embodiments, the client device 16 comprises a processor and data storage architecture 101 shown in FIG. 9. The architecture 101 may be used with other architectures such as architectures 50 and 90. The architecture 101 comprises a fingerprint sensor 103, which may be sensor 33, a processor block 105, an application processor 106, a secure enclave processor 107, a data repository 108, and a secure data repository 109. The sensor 103 may comprise an encryption or security function or module to send encrypted data to the processors 106 and/or 107.

The processor block 105 may comprise an application processor 106 and a secure enclave processor 107. Each of these processors can include multiple processors, multiple cores, or reside on the same processor. The application processor 106 can be a general processor, responsible for several processing tasks of the device it resides within. The secure enclave processor 107 can be specially and/or specifically designed/configured to perform encrypted tasks, such as encrypting data associated with an authorized user's fingerprint/ID-pattern. Processor block 105 can be connected to sensor 103 by any number of wired or wireless connections, using any number of transmission protocols, such as a serial peripheral interface. Processor block 105 can also be connected to a data repository 108, which can include any number of mediums (e.g., magnetic material, solid state memory, etc.). Data repository 108 can include a secure data repository 109, which can include encrypted data, e.g., data associated with an authorized user's fingerprint/ID-pattern. Secure data repository 109 can be separate from the main repository 108 or a part of the main repository 108. In the example of fingerprint patterns (e.g., maps based on a scanned fingerprint pattern), the repository can store files for multiple authorized users, files for multiple fingers (e.g., 10) of each user, multiple files for each finger, etc.

In some embodiments, the some or all of the data associated with a user's fingerprint is maintained locally on the client device 16. Under this arrangement, the system 10 relies on the proper authentication of the user to the client device. Therefore the user's fingerprint data cannot be accessed at the authentication authority 12 or a central repository. In other embodiments, the data associated with the user's fingerprint is maintained remotely from the client device, such as at the authentication authority or on another remote computer or datastore.

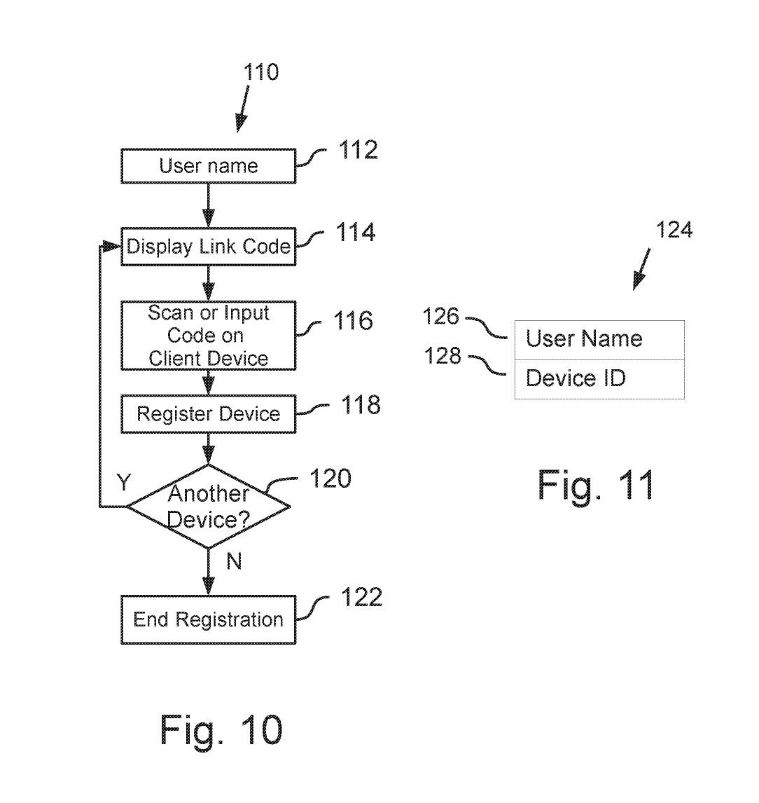

In the case were the user's fingerprint data is maintained on the client device, an exemplary user account registration function 110 is shown in FIG. 10. In some embodiments, the end user 22 can create an account with the system. In some embodiments the user's account may already be created, but the user may register a device with the system 10.

The authentication authority 12 may comprise a user database. The user database may comprise a plurality of user records, such as exemplary end user record 124 shown in FIG. 11, each end user record corresponding to an end user 22.

In some embodiments, the user can access the registration function by accessing a webpage or website from the client device or from another computing device. The authentication authority 12 may comprise a Web server capable of serving webpages which are accessible by the client device or another computing device. In the case where the user's account is not already created or is not completely created, at step 112, the user will be prompted to enter a username, such as an email address or other identifier. In some embodiments, the username is unique to the user. The username will then be received by the authentication authority 12 and stored in the username section 126 of the user record 124. Additional information related to the user may be requested and received at step 112 and stored in the user record.

At step 114, a link code will be displayed to the user, such as on a webpage served by the authentication authority or other server. In some embodiments the link code is a bar code, such as a matrix barcode, known as QR Code (Quick Response Code). In some embodiments, the link code is an alphanumeric code or other combination of characters, numbers and/or symbols. At step 116, the link code will be entered, scanned, or otherwise received by the client device 16. In some embodiments, the client device 16 comprises an application capable of causing the client device to read the barcode. If the user selects, the client device can read the barcode using a camera or other reading device of the client device. The barcode will correspond to the username. The application running on the client device will then be configured to cause the client device 16 to send to the authentication authority one or more messages associating the client device 16 with the username via the link code. The application running on the client device may cause the client device to generate a unique ID corresponding to the client device or the authentication authority may assign the client device a unique ID based on the communications received from the client device and the link code. The unique device ID will be stored in the device ID section 128 of the user record 124 at step 111.

The user may be prompted to register another device at step 120. If the user indicates that the user would like to register another device the system will proceed to step 114 and repeat steps 114 through 120. Additional device IDs corresponding to additional register devices will be stored in the device ID section 128 or another section of the user record. If the user indicates the user does not want to register another device, registration will end at step 122. In some embodiments, a table is maintained at the authentication authority with a user name corresponding to each device ID for which the username has already been registered.

The client device may provide features that insure only an authorized user can access the client device. When a user has proper access to the client device, relying on a correlation between the device ID and a username will ensure that the user of the client device is who the user says he or she is.

In some embodiments, a third party server can operate a Web server capable of serving webpages that are accessible by the client device or another computing device for registering a user or registering a client device(s). The authentication authority can provide to the third party server information sufficient to generate a barcode or the barcode itself for each corresponding user in a batch or on demand.

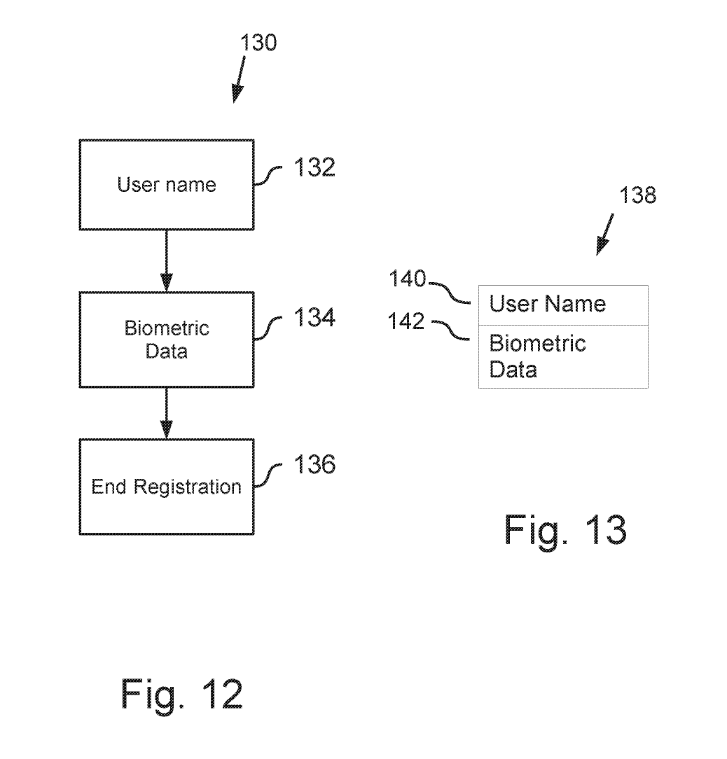

In the embodiments where the fingerprint data is stored remotely from the client device, such as at the authentication authority or at another remote storage or server, FIG. 12 shows a second embodiment user registration function 130. The registration function 130 is accessible in the same manner as user registration function 118, such as through a webpage accessible on the client device or another device or through an application running on the client device or another device. In the case where the user's account is not already created or is not completely created at step 132 the user will be prompted to enter a username, such as an email address or other identifier. The username will then be received by the authentication authority and stored in the username section 140 of the user record 138. Additional information related to the user may be requested and received at step 132 and stored in the user record.

At step 134, the user registration function will request fingerprint data from the client device. The client device will prompt the user to place one or more of the user's fingers on or about the fingerprint sensor 33 of the client device. When the client device detects that the user has placed a finger on the fingerprint sensor 33, the client device will then receive data corresponding to the user's fingerprint from the fingerprint sensor. The fingerprint data will then be transferred to the authentication authority 12 and stored in the biometric data section 142 of the user record 138. The fingerprint data may be encrypted by the client device before it is sent to the authentication authority for storage in the user record.

Optionally the user registration function 130 may request the user to provide fingerprint data for more than one of the user's fingers. In such case, the user registration function 130 will repeat step 134 for each finger or thumb for which the user registration function requests of the user or the user selects to provide. When the user registration function has received fingerprint data corresponding to one or more fingers of the user and no more fingerprint data is needed or desired, at step 136, the registration process ends.

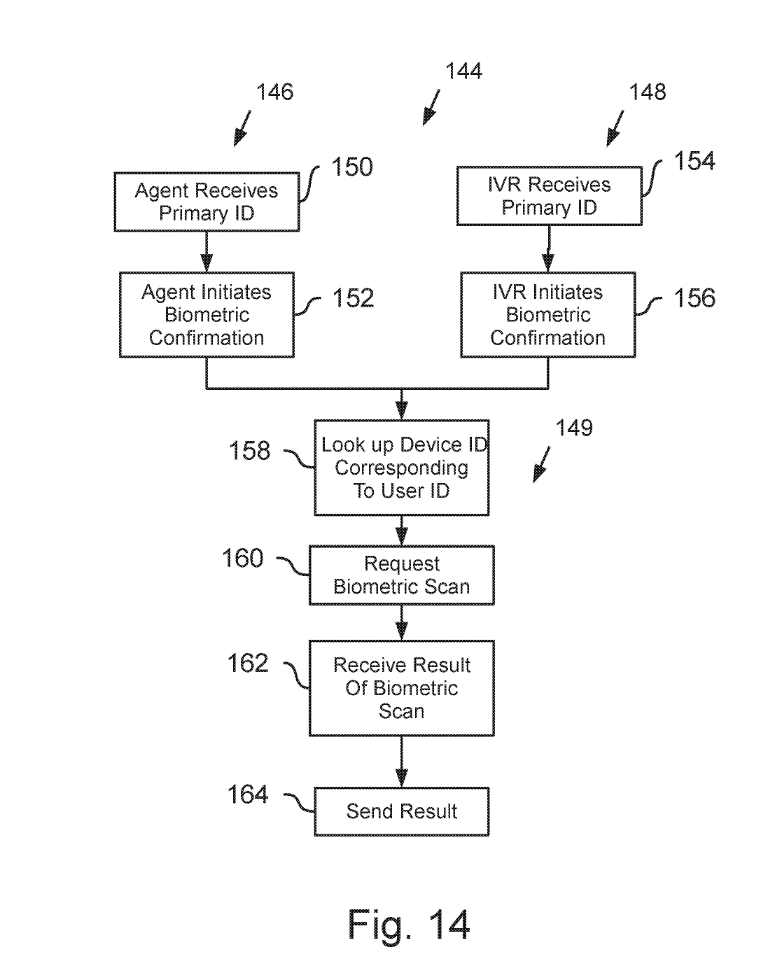

FIG. 14 shows an audio communication session authorization function 144. The authorization function may be used with a live human operator, such as shown in branch 146 or may be used with an interactive voice response (IVR) system, such as shown in branch 148. When an audio communication session occurs, there are circumstances where it is important or preferred to verify the identity of the person on the other end of the audio communication session or call. One non-limiting example of such a circumstance occurs when a bank account holder calls into the bank and the bank desires to confirm the identity of the caller. Another example is where a credit card holder calls the credit card issuer and the credit card issuer desires to confirm the identity of the caller. An audio communication session may comprise a telephone call, a voice over IP call, a wireless radio communication, a satellite telephone call, an audio chat session across the Internet, or other audio communication method. The audio communication session authorization function can also be used with video communications sessions, such as video conferencing, video chat, or other video communications.

In the case of a live human agent or operator, at step 150, the live human operator receives a call or audio communication session from a person. The agent requests that the person provide a primary ID, such as the person's name, username, account number, or other identifier(s). The agent then enters or conveys the person's primary ID to the call authority 14 and initiates a biometric confirmation at step 152. The call authority 14 then, as shown in FIG. 2, provides the person's primary ID to the authentication authority 12, wherein the primary ID is a user ID in the user database of the authentication authority. In the alternative, the call authority may provide to the authentication authority a user ID based on the person's primary ID. The call authority 14 may maintain a database associating primary IDs with user IDs, in the case where the user IDs are recognizable by the authentication authority but the primary ID is not. Then the authorization function 144 proceeds to step 158.

In the case where the caller initiates an audio communication session and an IVR system is used to respond to incoming audio communication sessions, then at step 154, the IVR receives a primary ID from the caller. The IVR may be hosted on or operated by the call authority 14 or may be hosted separately from the call authority but in communication with the call authority. An IVR is generally an automated system or device that may request information from the caller and detect responses.

The IVR may be configured to detect voice and or key inputs from a caller. The IVR may request that the caller provide the primary ID audibly or may request the user to input the ID using a numeric, alphanumeric, and/or other keypad. Therefore the call authority may be configured to receive the primary ID audibly and to convert the audio received into text or the call authority may be configured to receive understand the alphanumeric input through the user's keypad, such as by understanding DTMF (Dual-tone multi-frequency signaling) tones or other such tones corresponding to a numeric keypad.

In one example, the IVR may ask the caller what information the caller desires in the form of “please enter or say your account number.” In one example, the account number is the primary ID. After receiving the account number from the user the IVR may present the call with a menu of options, such as “press or say 1 for your account balance, press or say 2 for your credit limit . . . etc.” Then the user will press or say the corresponding number. After which the IVR may request biometric verification of the user's identity. Other menu(s) of options, questions, and responses can be used with or provided by the IVR.

The primary ID may be passed to the authentication authority 12 by the IVR, via the call authority, at step 156, or the call authority 14 may look up a user ID corresponding to the primary ID and transfer that user ID to the authentication authority. Then the authorization function proceeds to the biometric verification function 149 at step 158.

At step 158, the authentication authority looks up the device ID corresponding to the user ID received from the call authority 14. The authentication authority may query the user database for the user ID. When the authentication authority finds a user record having the corresponding user ID, the authentication authority will then use the device ID, such as may be located in the device ID section 128 of the user record, to send, at step 160, the device corresponding to the device ID a request for biometric authentication. In the case where the user record contains multiple device IDs because multiple devices have been registered, the authentication authority may be configured to use a default device ID specified in the user record. In the alternative, the authentication authority may be configured to send a biometric authentication request to all of the devices corresponding to the device IDs identified in the user record. In still another alternative, the authentication authority may receive from the call authority 14 a device ID along with the user ID specifying the device to which a biometric authentication request should be sent.

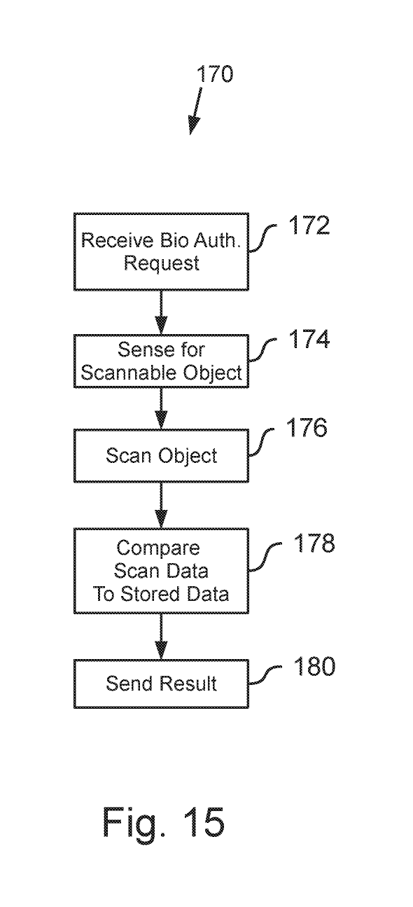

FIG. 15 shows a biometric comparison function 170 performed on the client device. At step 172, the client device receives a biometric authentication request from the authentication authority. The biometric authentication request may be accompanied with explanatory text or the client device may be preconfigured to provide an explanatory text based on a biometric authentication request received. An example of an explanatory text is “Acme Co. requests fingerprint identification, please place your finger on the fingerprint scanner/sensor.” Alternatively, the client device may be configured to advise the user of a request for a fingerprint scan and ask the user whether they'd like permit that requested fingerprint scan. The client device may notify the user which application on the client device is requesting a fingerprint scan.

At step 174, the client device detects or senses a scannable object, such as a fingerprint. The client device may be in a low-power state, where power consumption is reduced while waiting for a sensed object. A scannable object can be one close to the fingerprint sensor 33 or in contact with the fingerprint sensor 33. In some embodiments, the object may be “scannable” if it has a texture that can be detected. In some embodiments, an object may be scannable based on proximity, while the texture or lack thereof can be detected later in the exemplary process.

Once a scannable and or proximate object has been detected, the exemplary process can scan, using the fingerprint sensor 33, the object at step 176. The sensor results, which may vary depending on the type of sensor used (e.g., capacitive, optical, etc.) can then be used to compare with stored data to determine whether there is a match between the sensor results and the stored fingerprint data at step 178. If there is a match between the sensor results and the fingerprint stored data, then a match result will be returned at step 180 to the authentication authority at step 162. If there is not a match, then the no match result will be returned at step 180 to the authentication authority at step 162. The stored fingerprint data for comparing to the sensor results, will be stored in a storage of the client device.

In some embodiments, the stored data corresponding to a user fingerprint will be stored in the secure data repository 109. Such stored data will be retrieved from the secure data repository and used by either the secure enclave processor 107 or the application processor 106 or both to determine whether there is a match between the sensor results and the stored data. If there's a match between the sensor results and the stored data, then the user's fingerprint provided on or at the fingerprint sensor matches the stored data corresponding to a known user. Therefore, if there is a match, then the user has been authenticated by the fingerprint scan.

In some embodiments the scan results can be used to construct a map associated with (e.g. descriptive of) the scanned features of the objects texture, such as described in U.S. Patent Application Publication Number 2013/0308838. U.S. Patent Application Publication Number 2013/0308838 is herein incorporated by reference. In such case, the constructed map can be compared to one or more stored templates to determine whether or not there is a match.

One example of how a ridge flow map can be computed and stored follows. The exemplary map may contain a grid of integer directions, where each cell in the grid represents a pixel neighborhood in the image, such as an 8×8 pixel neighborhood. Ridge flow angles can be quantized, such as into 16 integer bidirectional units equally spaced on a semi-circle. In this example, starting with the vertical direction zero, direction units can be increased clockwise and represent incremental jumps of 11.25 degrees, stopping at direction 15 which is 11.25 degrees shy a vertical using this scheme, direction 8 is horizontal. A value of negative one in this map represents a neighborhood where no valid ridge flow was determined. Other exemplary methods of producing a ridge flow map are also possible, including different sizes, range values, matrix configurations, etc. Further, other map types are also possible, such as a quality map, a contrast map, etc.

Sensor 33 can scan a texture of an object. This texture can be translated into an associated map by sensor 33, application processor 106, and/or secure enclave processor 107. The secure enclave processor 107 can then retrieve encrypted templates (e.g., based on patterns associated with authorized users), and match the translated map with the encrypted templates. The secure enclave processor (e.g., via the application processor, operating system (OS), and input/output devices (I/O)) can then provide a result at step 180.

At step 162, the authentication authority receives the result of the biometric scan and forwards that result to the call authority at step 164. The results of the biometric scan tells the call authority whether or not the person in the audio communication session is who he or she says he is. If the results do not confirm the user's identity, the call authority can indicate either through the IVR system or through the call agent 24 a refusal to proceed or a refusal provide certain information, such as confidential or sensitive information. In the alternative, the call agent or IVR can ask the caller if he/she want to retry the fingerprint authentication, and if so can restart the process, such as at step 152, 156, or 160. If the results do confirm the user's identity, the call authority, the IVR system, and or the call agent 24 can proceed with actions requiring or preferring identity confirmation, such as the disclosures of confidential or sensitive information to user/caller, which the user/caller is authorized to access.

In the embodiments where the data associated with the authorized user's fingerprint is not maintained locally on the client device, but is instead maintained remotely, such as associated with the authentication authority 14 in section 142 of the user record, the biometric comparison function 170 is modified from that shown in FIG. 13 so that after the scan of the user's fingerprint is received by the client device, instead of comparing the result of the scan to store data on the local device, the result of the scan or data corresponding to the result of the scan is sent to the authentication authority. Then the authentication authority compares the received data to the stored data in section 143 of the user record to determine whether there is a match. In another embodiment, the authentication authority sends the fingerprint data stored in section 142 to the client device when it submits the biometric authentication request at step 172 to the client device. Then the client device precedes as shown in FIG. 9 and compares the scan result with the received fingerprint data and returns a match or no match result at step 180 based on that comparison.

In some embodiments, contemporaneously or after the results are sent at step 164, the authentication authority and or the call authority and or another system may record the results of the biometric scan request in a transaction database along with other data about the transaction. The transaction database or the records in the transaction database may be encrypted for security. In some embodiments, contemporaneously or after the results are sent at step 164, the results of the biometric scan request may be sent to a customer relationship management (CRM) system or database along with other information about the transaction.

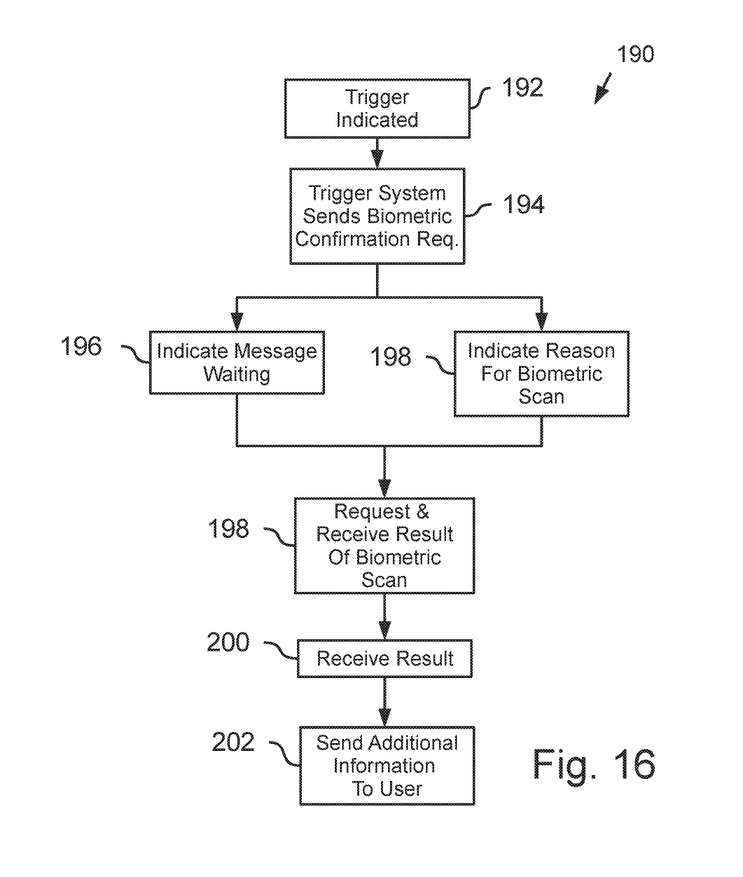

FIG. 16 shows an event triggered verification function(s) 190. A system(s) may use logic to send alerts to users based on some behavior, event, or occurrence. For example, a financial institution may send an alert to one of its account holders when certain suspicious transactions occur on the account holder's account. The alert may be in the form of a telephone call to the user requesting a call back in a confirmation that the transactions are valid. In other examples insurance companies may send alerts about new offers based on a policyholder's age, lifestyle change, or other factors. When a policyholder responds to such an alert, the insurance company may have an interest in ensuring that the responding person is the policyholder or other authorized person. Still further, medical organizations may inform clients about health changes or test results. The patient may be required to call in or login to a computer system and the medical organization has a desire to ensure that the caller or the person login is the person who is authorized to receive information about the changes or the test results. Numerous other examples exist where a behavior, event, or occurrence triggers a system to seek confirmation or other action from a user, account holder, or third party.

At step 192, a behavior, event, or occurrence recognized or received by the trigger authority 15 is indicated. At step 194, the trigger authority 15 sends to the authentication authority 14 a biometric confirmation request. The biometric confirmation request may comprise a user ID and optionally message information. The authentication authority looks up the user record corresponding to the user ID and identifies a device ID corresponding to the user ID. The authentication authority then will send a fingerprint verification request to the client device corresponding to the identified device ID along with message information. In some embodiments, the function 190 proceeds to step 196. In some embodiments function 190 proceeds to step 198.

When function 190 proceeds to step 196, the client device will provide a notice to the user, such as by a pop-up notification, that a message is waiting for the user of the client device and in order to access the waiting message the user must authenticate using the fingerprint sensor 33. The function 190 will then, at step 198, proceed with the biometric comparison function 170, with fingerprint data comparison and matching done on the client device or on the authentication authority, such as explained above. The results of the fingerprint authentication will be transferred to the authentication authority, and optionally to the trigger authority and/or other systems. If fingerprint authentication is successful, then at step 200, the authentication authority will transfer the message information to the client device and the client device will display or otherwise convey the message information to the user on the client device.

In some embodiments the message information is never held by the authentication authority, instead the message information can be conveyed directly to the client device from another system such as the trigger authority, when given permission by the authentication authority to do so after a successful fingerprint authentication messages received from the client device. In some embodiments, the message information is not received from the trigger authority or from another system until a successful fingerprint authentication result is received at step 200, after which the message information is received by the authentication authority and passed on to the client device. Such message information may be received in an encrypted format and passed to the client device in an encrypted format. Such encrypted information can then be decrypted by the client device.

In the embodiments where the function 190 proceeds from step 194 to step 198, substantive message information may be displayed to the user on the client device at the time when a fingerprint scan is requested. One exemplary substantive message may be, “ABC Bank needs you to approve a transaction from ACME Co. for $500. Please scan your finger to approve this transaction.” If the fingerprint authentication is successful then a message may or may not be provided back to the user on the client device at step 202, such as “Thank you for providing the approval.” It will be appreciated that any information could be conveyed in one or more messages to the user at step 202 after a successful biometric authentication has occurred.

In some embodiments, computer or machine artificial intelligence systems or algorithms may be used on the trigger authority 14 or another system connected to the trigger authority to determine whether to request a biometric confirmation. In one example, the artificial intelligence system/algorithm determines that a person missing his/her flight. At step 198, the system will indicate in a message to the person's mobile phone that her flight was missed and may provide one or more alternative flight options. Before or after the user selects one of the alternative options, the system, before booking, reserving, or finalizing the chosen option, will, at step 198, request and receive biometric fingerprint information. The system will compare the received fingerprint data with existing data associated with the user as explained above. If the fingerprint authentication is successful, then at step 200, the system take the additional steps, such as booking, confirming, and/or reserving the alternative flight option chosen by the user. In the alternative, the system can notify another system of the successful fingerprint authentication, and that other system can carry out appropriate further actions, such as booking.

In some embodiments, the trigger event or determination by computer or machine artificial intelligence systems or algorithms that biometric confirmation is needed by result in a call being made to the user's phone number. A person, recorded message, IVR, or artificial intelligence system can explain the reason for the call (e.g. unusual use of credit card), and request a biometric fingerprint scan (e.g. to confirm identity and transaction authorization). Therefore, during a voice call or following a voice call, the system initiate and carry out the biometric verification function 149.

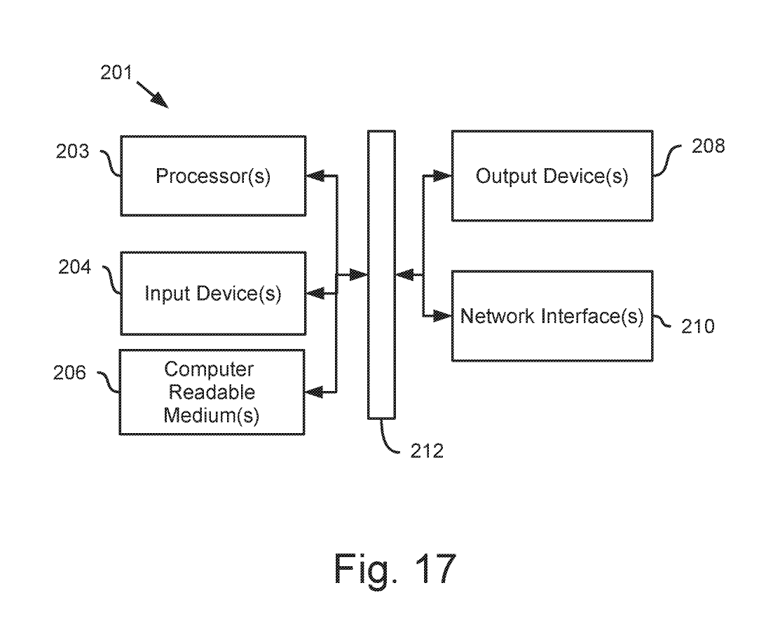

FIG. 17 provides a block diagram of an exemplary server computer architecture 201 for implementing the features and processes described herein, such as in reference to the authentication authority 12, the trigger authority 15, and/or other server side functionality. Other architectures are possible, including architectures with more or fewer components. In some embodiments, the architecture 201 comprises one or more communication channels 212, such as a bus(es), that connect one or more processors 203, one or more input device(s) 204, one or more output device(s) 208, one or more computer readable medium(s) 206, and one or more network interface(s) 210. The one or more communication channels 212 allow the transfer of data, communications, and control signals between the various components connected to the channels 212.

The network interface(s) 210 may comprise wired or wireless network interfaces, such as an Ethernet wired network interface. The input device(s) 204 may comprise a keyboard, a mouse, and/or a touch-sensitive display. The output device(s) 208 may comprises a display, such as an LCD display. The computer readable medium(s) 206 may comprise non-volatile media, such as optical or magnetic disks, or volatile media, such as RAM or memory.

The computer readable mediums 206 may comprise an operating system, network communication instructions, and the instructions for operating the authentication authority 12 and/or the trigger authority 15. The operating system can perform tasks, such as managing files and directories on the computer storage mediums 206, managing traffic on the one or more communication channels 212, recognizing input from input devices 204, and providing output to output devices 208, among other tasks. The network communications instructions can enable the establishing, transmitting, and/or maintaining of network communications.

The steps, functions, processes, and capabilities described herein can be provided in the form of instructions stored in a computer readable medium and executable by a processor of a computing device to achieve the corresponding functions, processes, capabilities, or results.

From the foregoing, it will be observed that numerous variations and modifications may be effected without departing from the spirit and scope of the invention. It is to be understood that no limitation with respect to the specific apparatus illustrated herein is intended or should be inferred. For example, one or more component embodiments may be combined, modified, removed, or supplemented to form further embodiments within the scope of the invention. As a further example, steps provided in the flow diagrams of the figures, could be carried out in a different order to achieve desired results. Further, steps could be added or removed from the processes described. Therefore, other embodiments and implementations are within the scope of the invention.

The invention claimed is:

1. A method of biometrically confirming an identity of a caller, comprising the steps of:
identifying, on a computer, a caller electronic device corresponding to a caller identification information received from a caller during an audio call;
sending a fingerprint scan request via a computer network to the caller electronic device during the audio call;
receiving on the computer a result following the fingerprint scan request from the caller electronic device during the audio call;
providing a caller identity confirmation if the result indicates an obtained fingerprint data from a fingerprint scan on the caller electronic device,
occurring during the audio call resulting from the fingerprint scan request, matches a stored fingerprint data associated with the caller.

2. The method of claim 1, comprising the steps of:
after sending, prompting on the caller electronic device for the caller to place a finger of the caller on or adjacent a fingerprint sensor of the caller electronic device;
obtaining the obtained fingerprint data corresponding to a fingerprint of the caller from the fingerprint sensor;
comparing the obtained fingerprint data to the stored fingerprint data associated with the caller to determine if there is a match;
sending to the computer the result of the comparing

3. The method of claim 2, wherein the step of comparing comprises the step of retrieving the stored fingerprint data from a datastore of the caller electronic device.

4. The method of claim 2, wherein the step of comparing comprises the step of retrieving the stored fingerprint data from a datastore located remote from the caller electronic device.

5. The method of claim 2, wherein the step of comparing comprises the step of retrieving the stored fingerprint data from a datastore associated with the computer.

6. The method of claim 2, wherein the step of comparing comprises the step of retrieving the stored fingerprint data from a secure datastore of the caller electronic device; and comparing, with a secure processor of the caller electronic device, the obtained fingerprint data to the stored fingerprint data associated with the caller to determine if there is a match, the secure data store coupled to the secure processor.

7. The method of claim 1, comprising the step of receiving the caller identification information from an interactive voice response system.

8. The method of claim 1, comprising the step of receiving the caller identification information from a call authority computer system.

9. The method of claim 1, comprising the step of after providing the caller identity confirmation, providing to the caller electronic device a message comprising confidential information.

10. The method of claim 1, comprising the step of, after providing the caller identity confirmation, causing the caller electronic device to convey to the caller a message comprising confidential information.

11. The method of claim 1, wherein the step of receiving is further defined in that the result comprises an indication whether the obtained fingerprint data from the fingerprint scan on the caller electronic device, occurring during the audio call resulting from the fingerprint scan request, matches the stored fingerprint data associated with the caller.

12. The method of claim 1, wherein the result comprises the obtained fingerprint data from the fingerprint scan on the caller electronic device; and comprising the step of comparing, on the computer, the obtained fingerprint data to the stored fingerprint data associated with the caller to determine if there is a match.

13. A computer readable medium containing program instructions for biometrically confirming an identity of a caller, wherein execution of the program instructions by one or more processors of a computing device causes the one or more processors to carry out the steps of:
identifying a caller electronic device corresponding to a caller identification information received from a caller during an audio call;
sending a fingerprint scan request via a computer network to the caller electronic device during the audio call;
receiving a result following the fingerprint scan request from the caller electronic device during the audio call;
providing a caller identity confirmation if the result indicates an obtained fingerprint data, from a fingerprint scan on the caller electronic device occurring during the audio call resulting from the fingerprint scan request, matches a stored fingerprint data associated with the caller.

14. The computer readable medium containing program instructions for biometrically confirming the identity of a caller of claim 13, comprising the step of receiving the caller identification information from an interactive voice response system.

15. The computer readable medium containing program instructions for biometrically confirming the identity of a caller of claim 13, comprising the step of receiving the caller identification information from a call authority computer system.

16. The computer readable medium containing program instructions for biometrically confirming the identity of a caller of claim 13, comprising the step of, after providing the caller identity confirmation, causing the caller electronic device to convey to the caller a message comprising confidential information.

17. The computer readable medium containing program instructions for biometrically confirming the identity of a caller of claim 13, wherein the step of receiving is further defined in that the result comprises an indication whether the obtained fingerprint data from the fingerprint scan on the caller electronic device, occurring during the audio call resulting from the fingerprint scan request, matches the stored fingerprint data associated with the caller.

18. The computer readable medium containing program instructions for biometrically confirming the identity of a caller of claim 13, wherein the result comprises the obtained fingerprint data from the fingerprint scan on the caller electronic device; and comprising the step of comparing, on the computer, the obtained fingerprint data to the stored fingerprint data associated with the caller to determine if there is a match.

19. A computer, comprising:
a processor;
a caller device identifying function executable by the processor to identify a caller electronic device corresponding to a caller identification information received from a caller during an audio call;
a fingerprint scan request function executable by the processor to send a fingerprint scan request via a computer network to the caller electronic device during the audio call;
a fingerprint scan result receiving function executable by the processor to receive a result, following the fingerprint scan request, from the caller electronic device during the audio call; and,
a identity confirmation function executable by the processor to provide a caller identity confirmation if the result indicates an obtained fingerprint data from a fingerprint scan on the caller electronic device occurring during the audio call resulting from the fingerprint scan request matches a stored fingerprint data associated with the caller.

20. The computer of claim 19, wherein the step of receiving is further defined in that the result comprises an indication whether the obtained fingerprint data from the fingerprint scan on the caller electronic device, occurring during the audio call resulting from the fingerprint scan request, matches the stored fingerprint data associated with the caller.

21. The computer of claim 19, wherein the result comprises the obtained fingerprint data from the fingerprint scan on the caller electronic device; and comprising a comparing function executable by the processor to compare the obtained fingerprint data to the stored fingerprint data associated with the caller to determine if there is a match.

22. A method of biometrically confirming an identity of an intended message recipient, comprising the steps of:
identifying, on a computer, a recipient electronic device corresponding to an intended message recipient;
sending a fingerprint scan request via a computer network to the recipient electronic device;
receiving on the computer a result following the fingerprint scan request from the recipient electronic device;
transmitting to the recipient electronic device a message for access by the intended message recipient if an obtained fingerprint data, from a fingerprint scan on the recipient electronic device resulting from the fingerprint scan request, matches a stored fingerprint data associated with the intended message recipient.

23. The method of claim 22, comprising the steps of:
after sending, prompting on the recipient electronic device for a recipient to place a finger of the recipient on a fingerprint sensor of the recipient electronic device;
obtaining the obtained fingerprint data corresponding to the recipient's fingerprint from the fingerprint sensor;
comparing the obtained fingerprint data to the stored fingerprint data associated with the intended message recipient to determine if there is a match;
sending to the computer the result of the comparing.

24. The method of claim 23, wherein the step of comparing comprises the step of retrieving the stored fingerprint data from a datastore of the recipient electronic device.

25. The method of claim 23, wherein the step of comparing comprises the step of retrieving the stored fingerprint data from a datastore located remote from the recipient electronic device.

26. The method of claim 23, wherein the step of comparing comprises the step of retrieving the stored fingerprint data from a datastore associated with the computer.

27. The method of claim 23, wherein the step of comparing comprises the step of retrieving the stored fingerprint data from a secure datastore of the recipient electronic device; and comparing, with a secure processor of the recipient electronic device, the obtained fingerprint data to the stored fingerprint data associated with the recipient to determine if there is a match, the secure data store coupled to the secure processor.

28. The method of claim 22, comprising the step of receiving information identifying the intended message recipient from an interactive voice response system.

29. The method of claim 22, comprising the step of receiving information identifying the intended message recipient from a call authority computer system.

30. A method of biometrically confirming whether a transaction is authorized, comprising the steps of:
identifying, on a computer, an authorized electronic device corresponding to a transaction and an authorized user;
sending a fingerprint scan request via a computer network to the authorized electronic device;
receiving, on the computer, a result following the fingerprint scan request from the authorized electronic device;
indicating the transaction is authorized if an obtained fingerprint data, from a fingerprint scan on the authorized electronic device resulting from the fingerprint scan request, matches a stored fingerprint data associated with the authorized user.

31. The method of claim 30, comprising the steps of:
after sending, prompting on the authorized electronic device for the authorized user to place a finger of the authorized user on a fingerprint sensor of the authorized electronic device;
obtaining the obtained fingerprint data corresponding to a fingerprint of the authorized user from the fingerprint sensor;
comparing the obtained fingerprint data to the stored fingerprint data associated with the authorized user to determine if there is a match;
sending to the computer the result of the comparing.
